(19) United States
(12) Patent Application Publication
(10) Pub. No.: US 2026/0183773 A1
(43) Pub. Date: Jul. 2, 2026

(54) SYSTEM AND METHOD FOR RECOVERING DESIRED MATERIALS USING A PAN MILL

(71) Applicant: Thomas A Valerio, Atlanta, GA (US)

(72) Inventor: Thomas A Valerio, Atlanta, GA (US)

(21) Appl. No.: 19/336,332

(22) Filed: Sep. 22, 2025

Related U.S. Application Data
(63) Continuation of application No. PCT/US24/20771, filed on Mar. 20, 2024.
(60) Provisional application No. 63/453,395, filed on Mar. 20, 2023.

(51) Int. Cl. B03B 9/06; B02C 23/20; B03B 5/34; B03B 5/48; B03C 1/10; B03C 1/23; B03C 1/30

(52) U.S. Cl. CPC B03B 9/061; B02C 23/20; B03B 5/34; B03B 5/48; B03C 1/10; B03C 1/23; B03C 1/30; B03C 2201/18

(57) ABSTRACT

A method for recovering metals from waste, in which the material is screened to isolate nonfibrous feedstock. This nonfibrous feedstock is then crushed using a pan mill to further separate it, resulting in a mixture consisting of a metal fraction and a non-metal residue. The metal fraction can then be collected. Additionally, a system employing this method is utilized to treat such materials efficiently.

### CROSS-REFERENCE TO RELATED APPLICATION

This application is a continuation of International Patent Application No. PCT/US 24/20771, filed on Mar. 20, 2024, which claims the benefit of U.S. Provisional Ser. No. 63/453,395, filed Mar. 23, 2023, each of which is incorporated by reference herein in its entirety.

### TECHNICAL FIELD

This application relates to systems for separating desired material from waste like automotive shredder residue (ASR), electronic waste, incinerator ash and the like. More specifically the application relates to systems for recovering of ferrous and nonferrous materials by reducing the size of the waste material to make the separation process easier using a pan mill.

### BACKGROUND

Annually, over 15 million vehicles in the United States reach the end of their useful life. The economic and ecological imperatives have heightened the importance of recovering metals and other materials from these scrap vehicles. The recycling process for automobiles and white goods, such as refrigerators and electronics, in the United States and Europe typically starts with the shredding of these items after the removal of specific components, notably bulk refrigerants. Following shredding, the metallic content within the shredded material is isolated and recycled. Meanwhile, the non-metallic residue, historically deemed waste and destined for landfills, is now being reclaimed, separated, cleaned, and recycled. This residue commonly consists of various types of plastics, including polypropylene (PP), polyethylene (PE), polyvinyl chloride (PVC), acrylonitrile butadiene styrene (ABS), high impact polystyrene (HIPS), ABS/polycarbonate (ABS/PC) blends, polycarbonate (PC), and various nylons. To use the incinerator waste and reduce the environmental impact, treatment methods have been introduced and the waste has been classified and separated to promote recovery.

Accordingly, there is always a need for improved methods for separating and classifying waste.

### SUMMARY

This application discloses a process for the recovery and separation of materials from a waste stream containing both ferrous and nonferrous materials, specifically designed for high efficiency and lower operational costs. The process can utilize a compression or pan mill.

One aspect includes a process beginning with the delivery of shredder residue to a concentration unit, where the residue is divided into lighter and heavier fractions through air classification or gravity separation techniques. Following this, both fractions undergo screening to segregate materials based on size, enhancing the efficiency of subsequent processing steps, which include processing by a pan mill.

The material, post-screening, can be transferred to a hopper or surge hopper, regulating the flow to ensure consistent feeding into the pan mill. The pan mill serves to crush and grind the materials into finer particles, particularly effective for hard materials like metals, facilitating their reclamation with reduced losses. The material may also be shredded.

Following crushing and grinding by the pan mill, the material can undergoe secondary screening to remove oversized items and flats, helping to ensure appropriately sized particles proceed. The process may include a dewatering step to remove excess water, followed optionally by clarification, where solid particles are separated from water, allowing for the recovery of fine materials.

Another aspect includes a system having a batch feeder and screening mechanism for dispensing and sizing the initial waste material. Materials larger than a specific size threshold are processed in the wet pan mill to reduce their size below the set threshold, enhancing the efficiency of material recovery and separation.

Another aspect includes a process for separating ferrous and nonferrous materials from a waste stream. The waste stream can include automobile shredder residue (ASR) and water, and the ASR is separated using a pan mill. The waste stream may be combined with water, and the wet pan mill can be utilized for crushing and grinding the waste materials. The wet pan mill may be capable of elongating metal particles by 3 to 20 times their original size, enhancing the separation and recovery process.

Another aspect includes a method for recycling components from automobile shredder residue (ASR), having the steps of: concentrating the shredder residue into lighter and heavier fractions; screening both fractions to remove different sizes of particles; transferring the screened material to a surge hopper; and crushing and grinding the material in a wet pan mill.

Another aspect includes a method involving the steps of: conducting secondary screening to remove oversized items and flats; dewatering the processed material to reduce moisture content; and optionally clarifying the dewatered material to separate solid particles from water.

Another aspect includes a method for recovering metals from metal-based waste that involves separating any fibrous materials from the metal-based waste to leave a non-fibrous feedstock; combining the feedstock with water; applying a pan mill to the feedstock to separate the metals from the non-fibrous feedstock; and collecting the metal fraction and the residue. The pan mill may include a clevis arrangement. The method may include using a density separator or a magnetic drum.

Another aspect includes a system having a source of ASR with water, a pan mill to separate metals from the ASR, and a collector for collecting the separated metals. A system can have a screen, or a density separator is connected to the pan mill for separation of materials by specific gravity. The system can have a plurality of dewatering screens installed in the system for eliminating oversized material.

Another aspect includes a method of recovering metals from automobile shredder residue (ASR) or incinerator bottom ash that includes separating the ASR or incinerator bottom ash into different particle size groups; combining the ASR or incinerator bottom ash with water; concentrating the ASR or incinerator bottom ash; conveying the ASR or incinerator bottom ash to a pan mill for crushing and metal separation; screening the ASR or incinerator bottom ash at a predetermined size; dewatering the ASR or incinerator bottom ash; and collecting metals from the ASR or incinerator bottom ash. The predetermined size can be less than 1 mm. The concentrator can separate the material into a first density material and a second density material.

Another aspect includes the pan mill phase having a clevis setup comprising a clevis bracket and a clevis pin that fastens the clevis bracket to a corresponding attachment point. The clevis setup facilitates adjustable variations in the angle and positioning of wheels relative to the milling pan.

Another aspect includes a pan mill having a milling pan for containing milling media and material to be milled; a central rotating shaft vertically positioned within said milling pan; one or more milling elements attached to said central rotating shaft for milling the material; a clevis setup comprising a clevis bracket.

This process provides a systematic approach for reclaiming, recovering, and obtaining desired materials from various waste streams, utilizing a wet pan mill to ensure high-capacity processing with low operational costs. The method accommodates different types of waste streams, making it versatile and economically beneficial, particularly for recycling industries.

### BRIEF DESCRIPTION OF DRAWINGS

FIG. 1 illustrates one embodiment of a method for utilizing a pan mill to separate materials like automotive shredder residue (ASR);

FIG. 2 illustrates another embodiment for employing a pan mill in the separation of materials such as ASR;

FIG. 3 illustrates another embodiment for using a pan mill to segregate materials akin to ASR;

FIG. 4A shows a typical example of a pan mill; and

FIG. 4B shows another example of a pan mill, this one featuring a clevis setup.

### DETAILED DESCRIPTION

This application provides systems and methods for recovering metals from waste streams. It covers both wet and dry process applications, such as streams originating from preconcentrators, water table concentrators, gold shaking tables (like those produced by Diester and Wilfery), sink-float tanks, snail drums, barrel washers, as well as processes using heavy media, DMS separators, hydro-cyclones, and others. Similarly, dry processes might include roughers like air aspirator Z box, widely used in Europe for pre-concentrating automobile shredder residue. These methods are well-known to those skilled in the art.

One embodiment includes separating ferrous and nonferrous materials, with applications varying from automobile shredder residue (ASR) to different types of incinerator ash. A specific method involves using a wet pan mill, known for high capacity and low operational costs, to reclaim, recover, and obtain valuable materials from metal-containing waste streams. Also referred to as a wet pan grinding mill or wheel pan mill, an example being the Quartz Mill or Chilean Mill, this equipment utilizes the convex-concave principle to crush ores, resulting in products with minimal slime and well-polished particles free of tarnish. This ensures enhanced recovery rates, particularly for sulfides and gold. The wet pan mill functions as a comprehensive milling and mixing device, performing various actions such as crushing, breaking, and pressing through grids. It effectively flattens metals, allowing for further reclamation with reduced losses.

The waste stream applicable here includes not just ASR but also electronic waste and incinerator ash. Water or other liquids facilitate the separation of different material fractions. Notably, the wet pan mill can extend metal lengths by 3 to 20 times.

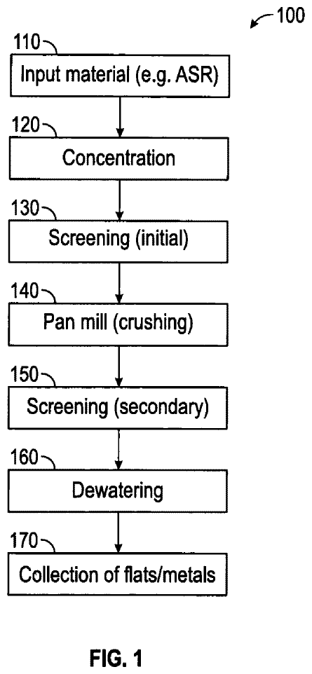

FIG. 1 shows a material recovery process for separating and recycling components from ASR, which typically contains a mix of metals, plastics, glass, and fibers. The process begins with the exemplary input material ASR (input material (110)) being subjected to concentration (120) with water. This initial stage involves dividing the residue into lighter and heavier fractions, often employing techniques such as air classification or gravity separation. The lighter materials often consist of plastics, foam, and fibers, while the heavier materials are composed of metals, glass, and other dense substances. Water can be added to or present with the materials during this stage.

Initially, the material can be screened (130) to separate it based on particle size, dividing it into light and heavy fractions. This segregation aids in making subsequent processing steps more efficient by employing mechanical screens that categorize materials into different size groups.

After screening, materials can optionally be transferred to a hopper or Surge Hopper, which serves as a buffer, regulating the flow to ensure consistent delivery to downstream processes. This step helps in managing the material supply to the pan mill.

Following this, the screened materials, or those from the hopper, are crushed in a Pan Mill (140). Here, materials are combined with water to create a slurry, with discretely sized portions from the surge hopper being introduced into the pan mill. The mill is instrumental in breaking down larger pieces into smaller, more manageable fragments, particularly useful for hard materials like metals and dense plastics.

Post-crushing, the materials from the pan mill (140) are subjected to another round of screening (150) to remove oversized items and flat materials, which could impede further processing. This step ensures that only suitably sized particles move forward, while larger metals and flat materials are collected for potential recycling or sale, thus adding value to the process.

Subsequently, the materials may undergo dewatering (160) to remove excess water, reducing moisture content and facilitating easier handling and processing. This stage often involves techniques like centrifugation, filtration, or pressing. The metals can then be recovered or further processed and collected (170).

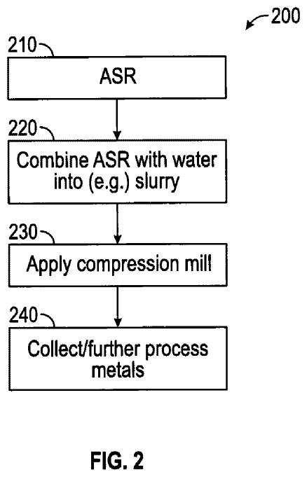

FIG. 2 illustrates another embodiment of a method (200) with the crushing steps. Here, the input materials are mixed with water to create a slurry (210), processed through a pan mill (220), and then metals are collected (230).

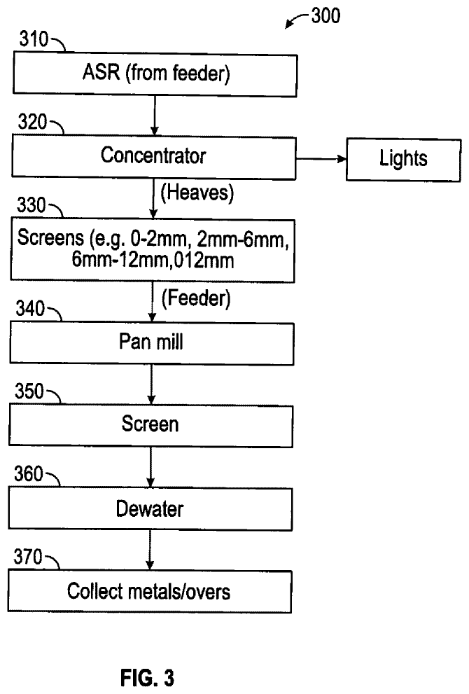

FIG. 3 illustrates a simplified version of the method (300). Here, the input materials (310) are fed to a concentr are mixed with water to create a slurry (210), processed through a pan mill (220), and then metals are collected (230). Optionally, the material can be subjected to clarification: Following dewatering, the slurry can be transferred to a clarifier, where solids settle from the water, aiding in the recovery of fine materials, including metal fines that can then be recycled.

The material can be initially screened (130). After separation, both the light and heavy fractions are screened to remove different sizes of particles. This can help in segregating materials based on size, making subsequent processing steps more efficient. The screening usually involves mechanical screens that sort materials into different size categories.

The screened material can be placed optionally into a hopper or Surge Hopper. The hopper acts as a buffer and regulates the flow of materials to ensure a consistent feed to downstream processes. The combination or a search hopper allows for managing the supply of materials to the pan mill.

In one embodiment, the system for separating material to obtain desired materials can include a batch feeder to dispense incinerator ash, ASR or other similar waste containing various sizes of materials into a screen. The screen has a screen that allows materials about over millimeters (mm) or less to pass through. Various sized-fractions of materials can be removed from the system or further manual and/or automatic processing. In this example, materials having a size over 2 mm can be sent to a wet pan mill and be less than 2 mm after processing. In another example the material can have a size of over 1 mm and can have a size of under 1 mm after processing.

FIG. 3 illustrates another exemplary method where the initial material (310) is fed into a concentrator (320). The lighter materials are removed, and the heavier materials are screened (330) into distinct size categories, such as 0-2 mm, 2-6 mm, 6-12 mm, and 12 mm or greater. The screened materials are then fed into the pan mill (340) in more uniformly sized batches. Following this, a secondary screen is used to either retrieve the material or further process it. The materials can then be dewatered (360), and the metals, which are the oversize materials from the screening process, can be collected.

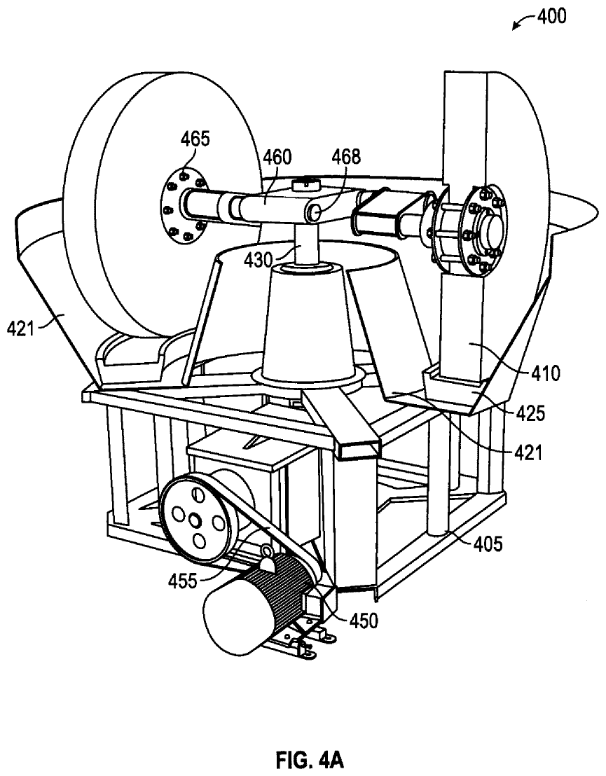

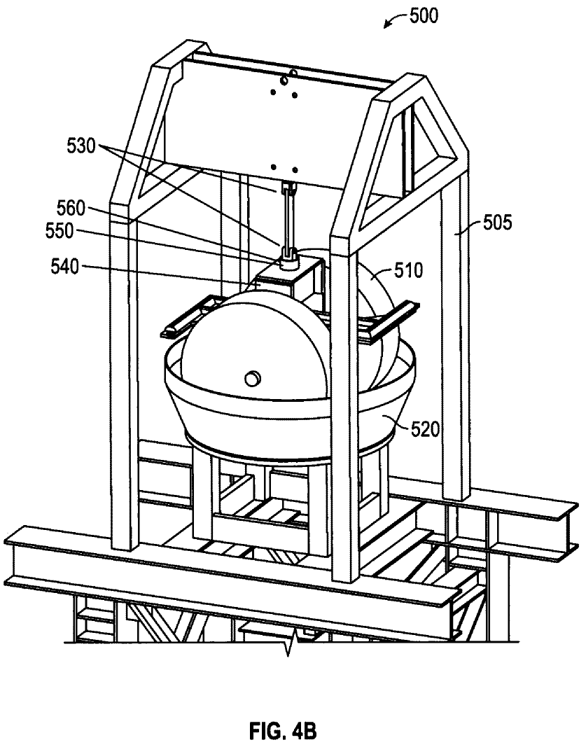

FIG. 4A illustrates an example of pan mills (400) within a frame (405). Each pan mill (400) includes a large, circular pan (420) supported by a central driving shaft (430) equipped with bearings. This pan base (421), along with the grinding basin (425), is constructed from steel or another robust material. Mounted centrally in the pan is a vertical shaft (430), to which mixing and grinding elements such as wheels or mullers (420) are attached. These grinding components are crafted from materials that are both strong and resistant to wear. The grinding elements (420) may feature ridges or other textures on their bases, enhancing the milling action within the grinding base (421). The operation of the pan mill (410) is powered by an engine (540) connected via a belt (455), driving the mechanism including the crank arm (460) (and crank shaft (468)) and wheel hub (465). This setup allows the pan mill to function based on the principles of low speed and high pressure applied to the ore particles. As materials are fed into the rotating pan, the grinding wheels press and roll over the materials, effectively crushing and pulverizing them against the pan's base (421).

FIG. 4B shows an alternative pan mill design (500) situated within a frame (505), incorporating a clevis setup. This model mounts the grinding rollers or wheels onto arms or levers, which are then connected to a central pivot or hub using a clevis joint, similar to the design displayed in FIG. 4A. The pan mill (500) features a base (520) and grinding elements (510). The clevis joint, a U-shaped bracket, secures the components (specifically the arms holding the grinding wheels) allowing them to pivot or rotate slightly. This mechanism promotes angular movement and precision adjustment of the grinding elements relative to the pan, thus boosting the mill's adaptability and operational efficiency. Moreover, this arrangement significantly reduces stress on the cylinder (530) and the roller bearings (560), which are optionally immersed in an oil bath (540) for enhanced smoothness and longevity. The pan mill can integrate with a hydraulic cylinder of various capacities (e.g., 30 or 40 or more tons). Rod clevis cylinder mounts provide a dynamic connection to a fixture, facilitating movement during operation. They consist of a threaded side attaching to the cylinder and a rod with a clevis pin on the other side linking to a work bracket. This arrangement can help ensure the thrust roller is submerged in an oil bath, maintaining operational connectivity with the wheel bearings. By modulating the hydraulic forces, operators can adjust the pressure and crushing forces applied by the mill. In essence, altering the hydraulic pressure varies the PSI exerted by the wheels on the material, optimizing crushing forces for different needs. This feature grants operators the ability to customize the position and pressure of the rollers, allowing for tailored grinding actions based on the material characteristics and required grind fineness.

In another embodiment, a screen (e.g., star screen) can be attached to the feeder. The screen may consist of tiny pores. These tiny pores, possibly less than 2 mm in size, are used to separate minute materials from the waste stream that are smaller than 2 mm. Generally, these particles are organic in nature. Particles larger than 2 mm may move to a wet pan mill for further grinding of the waste stream. In other examples, the screen sizes are greater than 4 mm, 6 mm, 8 mm, or 12 mm.

The feeder dispenses the waste stream containing various sizes of materials into the initial screen (e.g., a star screen or another type of screen). The initially screened material may run more efficiently through the process, thereby protecting the wet pan mill. Materials can be sent to the wet pan mill in either batch or continuous modes. Particularly, malleable metals from the wet pan mill are flattened.

The material can be discretely sized or separated. For example, devices that make multiple sized cuts can be used, such as 0-2 mm, 2-6 mm, 6-18 mm, 18-54 mm, and 54-100 mm, which are considered efficient cuts. Other cuts are suitable.

In another embodiment, material from the pan mill eventually proceeds to a density separator (e.g., falling velocity separator, rising current separator, or a jig) or is further screened, for example, using a nose cone. In one scenario, materials are separated making a cut at approximately 1.6 Specific Gravity (SG). Organic or non-metallic materials may be removed and discarded or used for solidification (e.g., absorbing wet or hazardous materials at a landfill) and/or as inorganic media.

In another embodiment, associating the pan mill with a screen size greater than 2 mm leads to unexpected results. The inner surface of the wet pan mill is covered with hard materials. The wet pan mill is utilized for size reduction of waste stream materials. It can act as a pulverizer, flattening metals and crushing materials like sand, rock, and glass.

Generally, the wet pan mill has a cylindrical shape and rotates around a horizontal axis. An internal cascading effect reduces the material to a fine powder.

In another embodiment, heavier materials containing metals or minerals are processed by a magnetic separator (e.g., a wet magnet). This includes low, medium, and high-intensity magnetic pulleys. At these pulleys, materials containing ferrous are removed from the product stream, leaving non-ferrous materials and minerals within the processing stream.

In another embodiment, a density separator can be directly connected or operatively connected to the wet pan mill. The density separator consists of an inlet and outlet for the input and output of waste stream materials for further processing. It works to separate materials using specific gravity and a paddle wheel, which is attached to the center-top portion of the density separator. The paddle wheel rotates, generating a disturbance in the water which then facilitates the separation of heavy and light materials. The paddlewheel speed may vary for each process, ranging from 30 to 60 rpm.

In another embodiment, material with the ferrous components removed is then processed through one or more roughers (e.g., jig, concentration tables, or wet or dry density separation). Heavier materials are further polished, and lighter materials are further processed and screened. This process divides mids from heavies, where mids can contain aggregate minerals and light metals (e.g., magnesium, aluminum).

A falling velocity separator or a density separator can be connected to the wet pan mill. The falling velocity separator sorts organic materials from the waste stream remaining after the star screen. It is used to separate heavy and light particles from the waste stream and operates based on specific gravity, typically around 1.6 SG. Materials ranging from 2 mm to 6 mm are separated based on the density of the materials. The materials with a specific gravity lower than 1.6 are discarded in a landfill, which is an area designated for disposing of waste materials.

Specific gravity, also known as relative density, is the ratio of the density of a substance to the density of a reference substance. The falling velocity separator operates based on specific gravities from 1 to 1.6 SG. Materials less than 1.6 SG are considered inorganic and are separated from the waste stream, whereas materials more than 1.6 SG are categorized as ferrous and nonferrous. Materials with higher specific gravity move to a wet magnetic drum for the separation of ferrous materials from the waste stream. Gravity separation can be employed before the pan mill to remove organics and light materials.

A rougher can be attached to the wet magnetic drum to sort the waste stream. After passing through the wet magnetic drum, the remaining waste stream consists only of nonferrous materials. These materials, both heavy and light, are then separated by the rougher, which can be a mechanical separator, density separator, or separator by physical motion (e.g., a table or mechanical separator like WO2019222558—FLUIDIZED INERTIA TABLE) used to separate materials from the waste stream.

The density separator includes a rough density separator that separates light and heavy materials from the waste stream. The heavier materials are then processed further in a finishing mechanical separator (e.g., WO2018090039—METHOD AND SYSTEM FOR RECOVERING METAL USING A HELIX SEPARATOR). The finishing density separator, positioned after the rough density separator, sorts heavy from light materials, which are then reprocessed in the rough density or mechanical separator. The heavier materials may include copper, aluminum, magnesium, or other nonferrous materials. Several dewatering screens and/or settling screws can be installed in the system.

The rough concentrate assembly may be associated with the rougher to further separate light materials. This assembly includes a sand scrubber, which generates friction on light materials to separate inorganic materials that may be attached to the ferrous and nonferrous materials present in the waste stream. The sand scrubber is essentially a wide rotating wheel with multiple pockets for holding sand particles used to scrub the light materials. After passing through the sand scrubber, the waste stream materials are divided into ferrous and nonferrous materials. Sand particles that may adhere to these materials can be removed using a high-pressure slurry pump.

The high-pressure slurry pump, functioning as a hydrocyclone, eliminates sand particles from ferrous and nonferrous materials. It may include a dewatering screen for draining water collected in a return box. The collected water is filtered for reuse. An eddy current chamber is utilized for further separation of nonferrous materials from the waste stream.

The “mids” or mid-sized materials may be processed using an eddy current or sensor, which specifically removes aluminum. The remnants from the eddy current have commercial value as an aggregate product (e.g., for asphalt or road bedding). In one instance, a sand washer or sand wheel can be employed for additional dewatering and polishing of the material.

The terms “heavier” and “lighter” refer to materials with relatively greater and lesser specific gravities, respectively. In the fluidic separator, the absolute weight is less significant than the buoyancy effect within the fluid. For example, a sixteen-ounce piece is lighter than a six-ounce piece if the latter has a greater specific gravity than the former.

Another embodiment includes an eddy current induced by changes in the magnetic field, which flows in closed loops. The eddy current is perpendicular to the plane of the magnetic field and is generated when a conductor moves through a magnetic field, causing a change in the intensity or direction of the magnetic field, thereby producing an eddy current.

Heavy metals (e.g., copper, brass, zinc, lead, stainless steel, cadmium, etc.) can be further processed and graded.

A system for reclaiming, recovering, and obtaining desired materials from a waste stream containing metals comprises a pan mill capable of milling and mixing, performing actions including crushing plastic parts, breaking hard parts, and pressing through grids to flatten metals for reclamation with fewer losses as fines. This device is operationally connected to a concentrator.

Although specific embodiments of the disclosure have been described in detail, this description serves purely for illustrative purposes. It should be understood that this description illustrates aspects relevant to a clear understanding of the invention. Certain aspects that would be apparent to those skilled in the art and therefore not contribute to a better understanding have been omitted for simplicity. Although these embodiments have been described, those skilled in the art will recognize many modifications and variations upon reviewing the foregoing description, all intended to be covered by this description.

1. A process for separating ferrous and non-ferrous materials from a waste stream, the waste stream comprising automobile shredder residue (ASR); the process comprising combining the ASR with water and processing the ASR in a wet pan mill.

2. A process as claimed in claim 1, wherein the wet pan mill is used to crush and grind the ASR slurry.

3. A process as claimed in claim 1, wherein the wet pan mill is capable of elongating metal particles by about 3 to about 20 times their original size.

4. A method for recovering metals from a metal-based waste, comprising:
separating fibrous materials from the metal-based waste to leave a non-fibrous feedstock; combining the feedstock with water; processing the feedstock in a wet pan mill to crush hard components and flatten malleable metals; and collecting the metal fraction and the residue.

5. A method as claimed in claim 4, wherein the wet pan mill includes a clevis arrangement.

6. A method as claimed in claim 5, further comprising separating ferrous materials from the processed material using a magnetic drum.

7. A method as claimed in claim 5, wherein the material is shredded prior to pan-milling.

8. A system comprising a source of ASR and water, a wet pan mill to separate metals from the ASR, and a collector for collecting the separated metals.

9. A system as claimed in claim 8, further comprising a screen.

10. A system as claimed in claim 8, wherein a density separator is connected to the pan mill for separation of materials by specific gravity.

11. A system as claimed in claim 8, wherein the system further comprises one or more dewatering screens for removing liquid from processed slurry.

12. A method of recovering metals from automobile shredder residue (ASR) or incinerator bottom ash comprising: separating the ASR or incinerator bottom ash into different particle size groups; combining the ASR or incinerator bottom ash with water; concentrating the ASR or incinerator bottom ash by gravity separation; conveying the ASR or incinerator bottom ash to a wet pan mill for crushing and metal separation; screening the ASR or incinerator bottom ash at a predetermined size; dewatering the ASR or incinerator bottom ash; and collecting metals from the ASR or incinerator bottom ash.

13. A method as claimed in claim 12, wherein the predetermined size is less than 2 mm.

14. A method as claimed in claim 12, wherein the concentrator separates the material into a first density material and a second density material.

15. A method of recovering metals from a metal-containing waste stream selected from automobile shredder residue (ASR), electronic waste, and incinerator ash, the method comprising: (a) screening the waste stream to separate particles by size into at least a light fraction and a heavy fraction; (b) feeding a portion of the screened material together with a liquid to form a slurry; (c) processing the slurry in a wet pan mill that mills and mixes the material to crush hard parts and flatten malleable metals; (d) post-mill screening to remove oversize and flattened metals; (e) separating remaining material by at least one of gravity separation and magnetic separation to divide heavier from lighter materials and to remove ferrous from non-ferrous metals; and (f) dewatering and collecting the metals.

16. The method of claim 15, further comprising subjecting mid-sized fractions to eddy current separation or sensor-based separation to remove aluminum, and collecting a residual aggregate product.

17. The method of claim 15, wherein the post-mill screening diverts oversize and flattened metals for direct recycling.

18. The method of claim 15, wherein the slurry is conveyed directly from the wet pan mill to a density separator having a paddle wheel driven at about 30-60 rpm.

19. The system of claim 15, wherein the density separator comprises a paddle wheel configured to generate fluid disturbance to separate heavy and light materials.

20. The system of claim 15, further comprising a sand scrubber and a high-pressure slurry pump configured as a hydrocyclone to remove adhering sand particles from metallic fractions.

21. The system of claim 15, further comprising an eddy current separator downstream of magnetic separation to separate non-ferrous metals.
